(19) United States
(12) Patent Application Publication
(10) Pub. No.: US 2026/0314892 A1
(43) Pub. Date: Oct. 15, 2026

(54) FILL LIGHT MODULE, CLEANING DEVICE, CONTROL METHOD AND RELATED DEVICE

(71) Applicant: Beijing Roborock Technology Co., Ltd., Beijing (CN)

(72) Inventors: Dan LIU, Beijing (CN); Ke PAN, Beijing (CN)

(21) Appl. No.: 19/531,732

(22) Filed: Feb. 6, 2026

Related U.S. Application Data
(63) Continuation of application No. PCT/CN2024/117485, filed on Sep. 6, 2024.

(30) Foreign Application Priority Data
Aug. 25, 2023 (CN) 202311084811.X

(51) Int. Cl. A47L 11/40; G05D 1/243; G05D 1/622; G05D 105/10

(52) U.S. Cl. CPC A47L 11/4002; A47L 11/4011; A47L 11/4061; A47L 11/4091; G05D 1/243; G05D 1/622; A47L 2201/02; A47L 2201/04; G05D 2105/10

(57) ABSTRACT

A fill light module, a cleaning device, a control method and a related device. The fill light module includes a mounting member, a light source and an adjustment member. During use, the fill light module may be connected to other electric appliances by means of the mounting member, and the mounting member also provides mounting positions for the light source and the adjustment member. When using fill light, the light source is turned on, and then the light source emits a light beam, and the adjustment member adjusts the boundary of the light beam to make a part of it gets close to the normal direction of the light beam. During the process of mounting the fill light module, the mounting manner of the fill light module can be adjusted, such that the light beam is arranged in a manner of facing the top of an electric appliance.

### CROSS-REFERENCE TO RELATED APPLICATION

The present disclosure is a U.S. Continuation Application of International Application No. PCT/CN2024/117485, filed on Sep. 6, 2024, which claims priority to Chinese Patent Application No. 202311084811.X filed on Aug. 25, 2023, both of which are incorporated herein by reference in their entireties for all purposes.

### TECHNICAL FIELD

Embodiments of the present disclosure relate to the technical field of electrical appliances, and in particular, to a supplementary lighting assembly, a cleaning device, a control method, and a related device.

### BACKGROUND ART

With the development of technologies, service robots are increasingly involved in all aspects of life, such as cleaning robots, food delivery robots, and commercial robots. All types of robots involve the functional requirements for active obstacle avoidance. The above functions require that robots can accurately avoid obstacles in complex environments, such as shoes, chairs, toys, or weight scales.

### SUMMARY OF THE INVENTION

A supplementary lighting assembly is provided according to a first aspect of the embodiments of the present disclosure. The supplementary lighting assembly includes: a mounting member;
a light source, the light source being disposed on the mounting member; and
an adjustment member, the adjustment member being disposed on the mounting member, and the adjustment member being configured to adjust a boundary of a light beam emitted by the light source, such that part of the boundary of the light beam contracts inward toward a normal direction of the light beam.

A cleaning device is provided according to a second aspect of the embodiments of the present disclosure. The cleaning device includes:
the supplementary lighting assembly according to any one of the above technical solutions; and
a cleaning device body, the supplementary lighting assembly being connected to the cleaning device body.

A control method for a cleaning device is provided according to a third aspect of the embodiments of the present disclosure. The control method is applicable to control the cleaning device according to any one of the above technical solutions, and includes:
collecting image information to acquire luminance information of the image information;
turning on the supplementary lighting assembly to acquire corrected image information in the case that the luminance information does not meet an identification requirement; and
performing navigation or obstacle avoidance for the cleaning device body based on the corrected image information.

A non-transitory computer-readable storage medium is provided according to a fourth aspect of the embodiments of the present disclosure.

The non-transitory computer-readable storage medium stores a computer program to implement the control method according to any one of the above technical solutions.

A control apparatus is provided according to a fifth aspect of the embodiments of the present disclosure. The control apparatus includes:
a memory storing a computer program; and
a processor executing the computer program,
where the processor, when executing the computer program, implements the control method according to any one of the above technical solutions.

### BRIEF DESCRIPTION OF THE DRAWINGS

By reading the detailed description of preferred embodiments below, various additional advantages and benefits will become clear to those of ordinary skill in the art. The drawings are provided solely for the purpose of illustrating the preferred embodiments and are not to be construed as limiting the scope of the present disclosure. In addition, the same components are denoted by the same reference numerals throughout the drawings. In the drawings:

FIGS. 1a and 1b respectively show schematic diagrams of distribution states of a divergence angle of a fill light in an X axis and a Y axis in the conventional technology;

FIG. 2 is a schematic structural diagram of a supplementary lighting assembly according to one embodiment of the present disclosure;

FIG. 3 is a schematic structural diagram of a supplementary lighting assembly in an exploded state from one perspective according to one embodiment of the present disclosure;

FIG. 4 is a schematic structural diagram of a supplementary lighting assembly in an exploded state from another perspective according to one embodiment of the present disclosure;

FIG. 5 is a schematic structural diagram showing a cleaning device in a state of use according to one embodiment of the present disclosure;

FIG. 6 is a partially enlarged schematic structural diagram of a supplementary lighting assembly of a cleaning device according to one embodiment of the present disclosure;

FIG. 7 is a schematic structural diagram showing a cleaning device in a state of use from another perspective according to one embodiment of the present disclosure;

FIG. 8 is a schematic diagram of a distribution state of a divergence angle of a supplementary lighting assembly of a cleaning device in an X axis and a Y axis according to one embodiment of the present disclosure;

FIG. 9 is a schematic structural diagram of a housing and a support of a cleaning device according to one embodiment of the present disclosure;

FIG. 10 is a schematic structural diagram of a housing and a support of a cleaning device from another perspective according to one embodiment of the present disclosure;

FIG. 11 is a schematic flowchart of a control method for a cleaning device according to one embodiment of the present disclosure;

FIG. 12 is a schematic flowchart of a control method for a cleaning device according to another embodiment of the present disclosure;

FIG. 13 is a structural block diagram of a non-transitory computer-readable storage medium according to one embodiment of the present disclosure; and

FIG. 14 is a structural block diagram of a control apparatus according to one embodiment of the present disclosure.

The correspondence relationships between reference numerals and component names in the drawings are as follows:
100 supplementary lighting assembly;
110 mounting member, 120 light source, 130 adjustment member, 140 shield;
111 first mounting member, 112 second mounting member, 113 positioning post, 114 guiding post, 131 adjustment surface;
210 cleaning device body, 220 housing, 230 support, 240 line laser assembly, 250 RGB image collection assembly, 260 protective cover, 270 docking beacon receiving assembly,
231 mounting hole, 261 hollowed-out portion.

### DETAILED DESCRIPTION

In order to better understand the above technical solutions, the technical solutions in the embodiments of the present disclosure will be described in detail below with reference to the drawings and specific embodiments. It should be understood that the embodiments of the present disclosure and specific features in the embodiments are detailed descriptions of the technical solutions in the embodiments of the present disclosure, but are not intended to limit the technical solutions in the present disclosure. The embodiments of the present disclosure and the technical features in the embodiments may be combined with each other as long as there is no conflict.

Currently, robots generally use a camera-based AI identification solution, and supplementary lighting is needed for the camera at night or in cloudy environments. However, in an electrical appliance in conventional technology, when a supplementary lighting function is activated, the light emitted by the supplementary lighting assembly will shine into human eyes, causing discomfort due to glare.

As shown in FIGS. 2 to 4, a supplementary lighting assembly 100 is provided according to a first aspect of the embodiments of the present disclosure. The supplementary lighting assembly includes: a mounting member 110; a light source 120, the light source 120 being disposed on the mounting member 110; and an adjustment member 130, the adjustment member 130 being disposed on the mounting member 110, and the adjustment member 130 being configured to adjust a boundary of a light beam emitted by the light source 120, such that part of the boundary of the light beam contracts inward toward a normal direction of the light beam.

The supplementary lighting assembly 100 according to the embodiments of the present disclosure includes the mounting member 110, the light source 120, and the adjustment member 130. During use, the supplementary lighting assembly 100 may be connected to other electrical appliances by means of the mounting member 110, and the mounting member 110 also provides mounting positions for the light source 120 and the adjustment member 130. When supplementary lighting is performed, the light source 120 is turned on, then the light source 120 emits a light beam, and the adjustment member 130 adjusts the boundary of the light beam, such that part of the boundary of the light beam contracts inward toward the normal direction of the light beam. During mounting of the supplementary lighting assembly 100, the mounting manner of the supplementary lighting assembly 100 may be adjusted, such that the light beam, whose boundary contracts inward toward the normal direction, is arranged toward the top of the electrical appliance. Based on this, the probability of light entering human eyes can be greatly reduced while the supplementary lighting intensity of the light beam for other regions is ensured, thereby improving user experience.

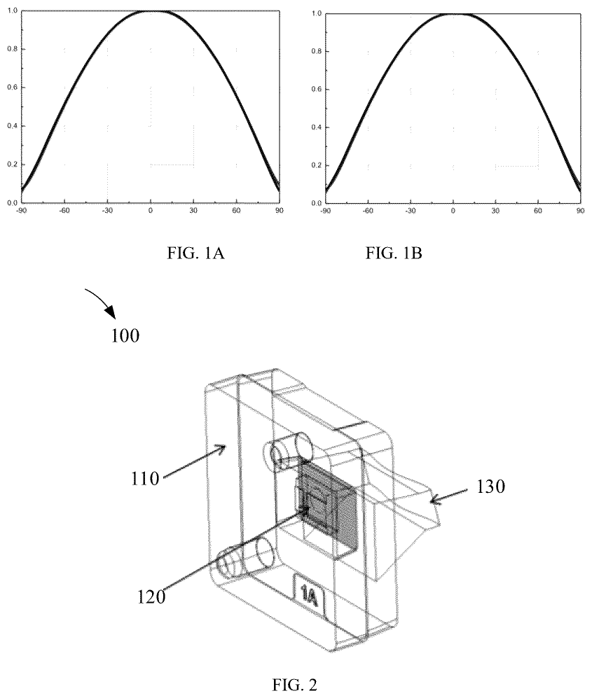

As shown in FIGS. 1a and 1b, the horizontal coordinate represents a divergence angle, the longitudinal coordinate represents light intensity, and the distribution of the divergence angle of a fill light in an X axis and a Y axis in the conventional technology is shown. The divergence angle of the light in both the X axis and the Y axis is about 120°. Based on this, during mounting of the fill light, no matter how the fill light is mounted, the shape of the light emitted by the fill light is cone-shaped. The distribution directions of light beam boundaries of such a light cone are the same, such that the light will enter human eyes during supplementary lighting. In order to achieve uniform luminance across the entire field of view of the camera, a high illuminance is required. However, the incidence of this light on human eyes will cause discomfort such as glare and dazzling. According to the supplementary lighting assembly 100 in the embodiments of the present disclosure, through the arrangement of the adjustment member 130, the light beam boundary of part of the light beam is adjusted. Based on this, the probability of light entering human eyes can be reduced, and user experience can be improved.

As shown in FIGS. 2 to 4, in one embodiment, the adjustment member 130 includes a curved lens, the curved lens is connected to the mounting member 110, and the light source 120 includes an LED light source 120.

In this technical solution, the configuration of the adjustment member 130 is further provided. The adjustment member 130 may include a curved lens. The refraction angle of light may be adjusted by means of the curved lens, and then a light beam boundary of the light beam may be adjusted, such that part of the light beam boundary contracts inward toward the normal direction of the light beam, thereby reducing the probability of light entering human eyes. Meanwhile, the curved lens exhibits high light transmittance, which can ensure the supplementary lighting intensity.

In this technical solution, the type of the light source 120 is further provided. The light source 120 includes an LED light source 120. This design ensures supplementary lighting intensity while offering higher energy efficiency and a low failure rate.

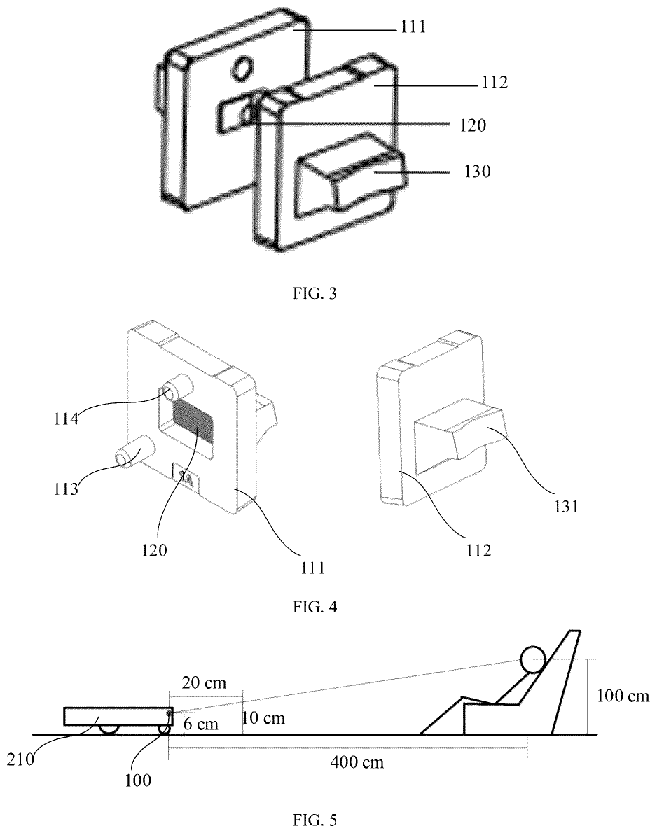

As shown in FIG. 4, in one embodiment, a surface of the curved lens opposite to the light source 120 is an adjustment surface 131, and the adjustment surface 131 is arranged obliquely. In this way, the adjustment of the boundary of the light beam by means of the curved lens is facilitated.

As shown in FIGS. 3 and 4, in one embodiment, the mounting member 110 includes: a first mounting member 111, the light source 120 being connected to the first mounting member 111; and a second mounting member 112, the adjustment member 130 being disposed on the second mounting member 112, and the first mounting member 111 being connected to the second mounting member 112.

In this technical solution, the configuration of the mounting member 110 is further provided. The mounting member 110 may include a first mounting member 111 and a second mounting member 112, the first mounting member 111 is configured to fix the light source 120, and the second mounting member 112 is configured to fix the adjustment member 130. Based on this, the assembly of the supplementary lighting assembly 100 is then completed simply by connecting the first mounting member 111 to the second mounting member 112. This configuration also facilitates adjusting the positions of the light source 120 and the adjustment member 130 and thereby can improve the assembly precision between the light source 120 and the adjustment member 130.

In some embodiments, both the first mounting member 111 and the second mounting member 112 may be plate-shaped.

In some embodiments, in the case that the adjustment member 130 includes a curved lens, an optical center of the light source 120 is aligned with an optical center of the curved lens, and the tolerance is +0.15 mm.

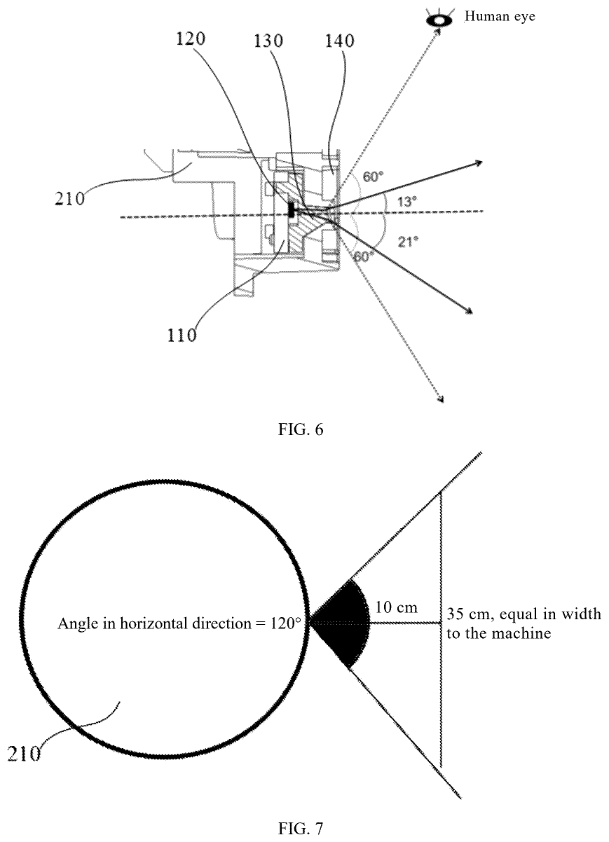

As shown in FIG. 6, in one embodiment, the supplementary lighting assembly 100 further includes a shield 140. The shield 140 is connected to the mounting member 110 and is located on a side of the mounting member 110 close to the adjustment member 130.

In this technical solution, the supplementary lighting assembly 100 may further include a shield 140. The shield 140 is connected to the mounting member 110, such that the shield 140 can protect the adjustment member 130, thereby reducing the probability of wearing of the adjustment member 130 and ensuring the supplementary lighting intensity.

It can be understood that the shield 140 may be made of a transparent material to facilitate the passage of light. The shield 140 may also be detachably connected to the mounting member 110 to facilitate maintenance of the adjustment member 130.

In one embodiment, a horizontal direction of light emission from the light source 120 is a first direction, a direction perpendicular to the horizontal direction is a second direction, and the light beam boundary, in the second direction, of part of the light beam emitted by the light source 120 contracts inward toward the horizontal direction.

In this technical solution, the way in which the light beam of the light source 120 contracts inward is further provided. A horizontal direction of light emission from the light source 120 is a first direction, a direction perpendicular to the horizontal direction is a second direction, that is, a vertical direction, and the light beam boundary, in the second direction, of part of the light beam emitted by the light source 120 contracts inward toward the horizontal direction. That is, the divergence angle of the light in the horizontal direction is greater than the divergence angle of the light in the vertical direction. Based on this, when the supplementary lighting assembly 100 is applied to the electrical appliance, light emitted in the horizontal direction can provide better supplementary lighting, and the decrease of the divergence angle of the light in the vertical direction can reduce the probability of light entering human eyes, thereby avoiding glare in the human eyes, and improving user experience.

As shown in FIGS. 5 to 8, a cleaning device is provided according to a second aspect of the embodiments of the present disclosure. The cleaning device includes the supplementary lighting assembly 100 according to any one of the above technical solutions and a cleaning device body 210, and the supplementary lighting assembly 100 is connected to the cleaning device body 210.

The cleaning device according to the embodiments of the present disclosure includes the supplementary lighting assembly 100 according to any one of the above technical solutions. Therefore, the cleaning device has all the beneficial effects of the supplementary lighting assembly 100 according to the above technical solutions.

During use of the cleaning device according to the embodiments of the present disclosure, when the cleaning device body 210 is in low light conditions, it may be difficult to capture clear image information, thereby affecting the navigation and obstacle avoidance precision of the cleaning device body 210. In this case, the supplementary lighting assembly 100 may be turned on. The light source 120 of the supplementary lighting assembly 100 emits light, such that the luminance of the image collected by the cleaning device body 210 may be improved, thereby ensuring the navigation and obstacle avoidance of the cleaning device body 210. In addition, when supplementary lighting is performed, the light source 120 is turned on, then the light source 120 emits a light beam, and the adjustment member 130 adjusts the boundary of the light beam, such that part of the boundary of the light beam contracts inward toward the normal direction of the light beam. During mounting of the supplementary lighting assembly 100, the mounting manner of the supplementary lighting assembly 100 may be adjusted, such that the light beam, whose boundary contracts inward toward the normal direction, is arranged toward the top of the electrical appliance. Based on this, the probability of light entering human eyes can be greatly reduced while the supplementary lighting intensity of the light beam for other regions is ensured, thereby improving user experience.

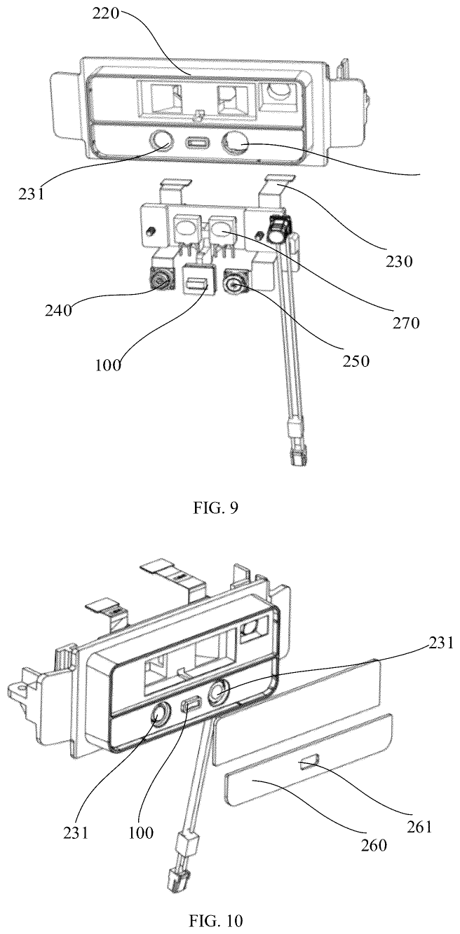

As shown in FIGS. 9 to 10, in one embodiment, the cleaning device further includes: a housing 220, the housing 220 being connected to the cleaning device body 210; and a support 230, the support 230 being configured to be connected to the housing 220. The supplementary lighting assembly is connected to the support 230.

In this technical solution, the structural composition of the cleaning device is further provided. The cleaning device may include a housing 220 and a support 230. A line laser assembly 240 and/or an RGB image collection assembly 250 may be connected to the support 230 by means of the support 230.

In this technical solution, the structural composition of the cleaning device is further provided. The cleaning device may include a housing 220 and a support 230. The support 230 may provide a mounting position for the supplementary lighting assembly. During assembly, the supplementary lighting assembly may be first assembled on the support 230, then the support 230 is connected to the housing 220, and finally the housing 220 is connected to the cleaning device body 210. Based on this, accurate positioning of the supplementary lighting assembly can be achieved.

In one embodiment, the cleaning device further includes a line laser assembly 240 and an RGB image collection assembly 250. The line laser assembly 240 and the RGB image collection assembly 250 are disposed on the support 230.

In this technical solution, the cleaning device further includes a line laser assembly 240 and an RGB image collection assembly 250. Based on this, the distance to an obstacle can be acquired by means of the line laser assembly 240, and the contour of the obstacle can be acquired by means of the RGB image collection assembly 250. Based on this, by using the RGB image collection assembly 250 together with the line laser assembly 240, the cleaning device body 210 can more accurately determine surrounding environment information, and the obstacle avoidance effect and operation effect of the cleaning device body 210 can be improved.

In this technical solution, the line laser assembly 240 and/or the RGB image collection assembly 250 are connected to the support 230, and the support 230 may provide mounting positions for the line laser assembly 240 and/or the RGB image collection assembly 250. During assembly, the line laser assembly 240 and/or the RGB image collection assembly 250 may be first assembled on the support 230, then the support 230 is connected to the housing 220, and finally the housing 220 is connected to the cleaning device body 210. Based on this, the modular assembly of a sensing assembly can be achieved, which facilitates accurate positioning of the line laser assembly 240 and/or the RGB image collection assembly 250.

In one embodiment, the cleaning device further includes a protective cover 260. The protective cover 260 is configured to cover at least one of the RGB image collection assembly 250, the fill light, and/or the line laser assembly 240.

In this technical solution, the cleaning device may further include a protective cover 260. By allowing the protective cover 260 to cover at least one of the RGB image collection assembly 250, the fill light, and/or the line laser assembly 240, dust and water resistance can be achieved, thereby prolonging the service life of the sensing assembly while improving sensing precision. In some embodiments, the protective cover 260 may be manufactured by using a single piece of cover plate or by stacking multiple pieces of cover plates.

In one embodiment, a region of the protective cover 260 corresponding to the supplementary lighting assembly is formed with a hollowed-out portion 261. In this way, the light transmittance of the supplementary lighting assembly can be improved, ensuring the supplementary lighting intensity.

In one embodiment, the housing 220 is formed with a mounting hole 231. The line laser assembly 240 and/or the RGB image collection assembly 250 transmit or receive a signal via the mounting hole 231.

By allowing the pore size of the mounting hole 231 to be slightly larger than the line laser assembly 240 and/or the RGB image collection assembly 250 when the mounting hole 231 is formed on the housing 220, the transmission and reception of signals of the line laser assembly 240 and/or the RGB image collection assembly 250 is facilitated, thus facilitating the accurate acquisition of the position and contour of the obstacle, and enabling the cleaning device body 210 to work more accurately.

In one embodiment, the cleaning device further includes:

a docking beacon receiving assembly 270. The docking beacon receiving assembly 270 is configured to receive a docking signal transmitted by a base station.

In this technical solution, the sensing assembly may further include a docking beacon receiving assembly 270. The arrangement of the docking beacon receiving assembly 270 facilitates the reception of the docking signal transmitted by the base station, such that the cleaning device body 210 can return to the base station based on the received signal, thereby facilitating smoothly performing operations such as charging, dust collection, and cleaning.

As shown in FIGS. 5 to 8, in one embodiment, a traveling direction of the cleaning device body 210 is a third direction, a height direction of the cleaning device body 210 is a fourth direction, and the light beam boundary, in the fourth direction, of part of the light beam emitted by the light source 120 contracts inward toward the third direction.

In this technical solution, the relationship between the light beam boundary of the light and the cleaning device body 210 is further provided. A traveling direction of the cleaning device body 210 is a third direction, a height direction of the cleaning device body 210 is a fourth direction, and the light beam boundary, in the fourth direction, of part of the light beam emitted by the light source 120 contracts inward toward the third direction. Based on this, when the supplementary lighting assembly 100 is turned on, the supplementary lighting assembly 100 may have a relatively large divergence angle in the traveling direction of the cleaning device body 210 and a relatively small divergence angle in the height direction of the cleaning device body 210. In this way, through supplementary lighting in the horizontal direction, the cleaning device body 210 may collect image information with sufficient luminance, and the probability of light entering human eyes is reduced, thereby improving user experience.

As shown in FIG. 5, in one embodiment, in the fourth direction, the included angle between a light beam boundary, facing the ground, of a light beam emitted by the light source 120 and the third direction is a first included angle, and the included angle between a light beam boundary, facing away from the ground, of the light beam emitted by the light source 120 and the third direction is a second included angle. The first included angle is greater than or equal to 21°, and the second included angle is less than or equal to 13°.

In this technical solution, parameters for the inward contraction of the light beam boundary are further provided. In the fourth direction, the included angle between a light beam boundary, facing the ground, of a light beam emitted by the light source 120 and the third direction is a first included angle, and the included angle between a light beam boundary, facing away from the ground, of the light beam emitted by the light source 120 and the third direction is a second included angle. The first included angle is greater than or equal to 21°, and the second included angle is less than or equal to 13°. That is, during the use of the cleaning device, in a direction of light emission from the supplementary lighting assembly 100, the included angle between an upward light beam boundary and the horizontal direction is less than or equal to 13°, and the included angle between a light beam boundary facing the ground and the horizontal direction is greater than or equal to 21°, such that the supplementary lighting assembly 100 has a relatively large divergence angle in the horizontal direction and the ground direction, and has a relatively small divergence angle in the upward direction. The divergence angle of an upper half portion in the vertical direction is compressed, thereby avoiding dazzling or glare caused by the light of the fill light entering human eyes. The divergence angle in the horizontal direction and the divergence angle of a lower half portion are kept at a large angle, thereby matching the size of a sweeper and meeting the requirements of short-distance identification and obstacle avoidance.

As shown in FIG. 5, taking one working scenario of the cleaning device as an example, a person sits at a position 400 cm away from the cleaning device, the height of human eyes from the ground is about 100 cm, and the supplementary lighting assembly 100 is mounted on the cleaning device at a position 6 cm away from the ground. To ensure that the light in the vertical direction does not enter human eyes, the upper divergence angle of the light field in the vertical direction may be compressed to 13°, and the divergence angle of the lower half portion in the vertical direction is greater than 21°, ensuring that the obstacle on the ground is illuminated. In this case, it can still be ensured that the supplementary lighting assembly 100 illuminates the obstacle with a height of 10.7 cm or less and at a common distance of 20 cm from the cleaning device body 210. The conventional height of the cleaning device body 210 is 9.5 cm, and the cleaning device body 210 will not get stuck provided that the obstacle has a height less than 10.7 cm.

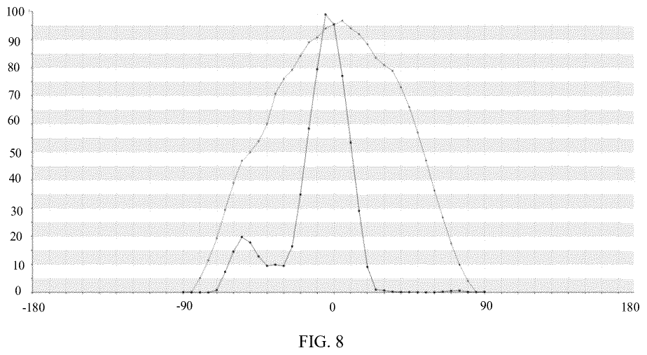

In some embodiments, for the parameters of the light beam emitted by the light source 120 after being adjusted by the adjustment member 130, reference may be made to the table below and FIG. 8.

TABLE 1
Parameters of light beam after adjustment

| | Direction | Full width | Half width+ | Half width− |
|---|---|---|---|---|
| 1 | Average | 66.570 | 32.177 | −34.392 |
| 2 | 0 deg | 35.015 | 13.803 | −21.212 |
| 3 | 90 deg | 98.125 | 50.552 | −47.573 |

As shown in FIG. 8, the horizontal coordinate represents a divergence angle, and the longitudinal coordinate represents light intensity. The divergence angle in the horizontal direction is 98.125°, and the divergence angle in the vertical direction is asymmetric, with the divergence angle of the upper half portion being 13.8° and the divergence angle of the lower half portion being 21.2°, such that the light beam, whose boundary contracts inward toward the normal direction, is arranged toward the top of the electrical appliance. Based on this, the probability of light entering human eyes can be greatly reduced while the supplementary lighting intensity of the light beam for other regions is ensured, thereby improving user experience.

As shown in FIG. 7, the light beam emitted by the supplementary lighting assembly 100 may have a divergence angle of 120° in the third direction, and this allows the cleaning device body 210 to see an obstacle that is 10 cm ahead and has a width of 35 cm, equal to the width of the cleaning device body 210, thereby ensuring that the cleaning device body 210 does not get stuck in the horizontal direction.

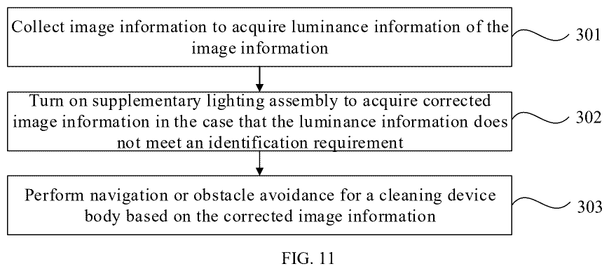

As shown in FIG. 11, a control method for a cleaning device is provided according to a third aspect of the embodiments of the present disclosure. The control method is applicable to control the cleaning device according to any one of the above technical solutions, and includes the following steps.

In step 301, image information is collected to acquire luminance information of the image information. It can be understood that the image information may be collected by means of the RGB image collection assembly on the cleaning device.

In step 302, the supplementary lighting assembly is turned on to acquire corrected image information in the case that the luminance information does not meet an identification requirement. It can be understood that after the image information is acquired, the image information may be parsed to plan a path for the cleaning device. During the parsing of the image information, if the luminance information is excessively low, the identification requirement may not be met. In this case, the supplementary lighting assembly may be turned on, so as to perform supplementary lighting by means of the supplementary lighting assembly, and then corrected image information is acquired.

In step 303, based on the corrected image information, navigation or obstacle avoidance is performed for the cleaning device body. It can be understood that since the corrected image information is acquired after the supplementary lighting assembly is turned on, the luminance of the corrected image information can meet the requirement. In this case, a basis for the movement of the cleaning device body may be provided based on the corrected image information, and then the cleaning device body is controlled to perform navigation or obstacle avoidance.

The control method according to the embodiments of the present disclosure is used to control the cleaning device according to any one of the above technical solutions. Therefore, the control method has all the beneficial effects of the cleaning device according to the above technical solutions.

In the control method according to the embodiments of the present disclosure, image information is first collected. If the image information can meet an identification requirement, the supplementary lighting assembly does not need to be turned on. If the image information cannot meet the identification requirement, the supplementary lighting assembly is turned on. Based on this, automatic control of turning on and off the supplementary lighting assembly can be achieved, and the supplementary lighting assembly is controlled to be turned on only when necessary. The corrected image information may be acquired by means of the supplementary lighting assembly, and thus a basis for navigation and obstacle avoidance of the cleaning device may be accurately provided based on the corrected image information. This can improve the precision of the movement of the cleaning device without irritating human eyes, resulting in a high user experience.

In one embodiment, the step of turning on the supplementary lighting assembly to acquire the corrected image information in the case that the luminance information does not meet the identification requirement includes: turning on the light supplement assembly to acquire first corrected image information in the case that the luminance information does not meet the identification requirement; increasing a duty cycle of the supplementary lighting assembly in the case that the luminance of the first corrected image information is less than a first threshold, and reacquiring image information until corrected image information that can meet the identification requirement is acquired; reducing the duty cycle of the supplementary lighting assembly in the case that the luminance of the first corrected image information is greater than or equal to a second threshold, and reacquiring image information until corrected image information that can meet the identification requirement is acquired; and using the first corrected image information as the corrected image information in the case that the luminance of the first corrected image information is greater than or equal to the first threshold and is less than or equal to the second threshold, where the value of the first threshold is less than that of the second threshold.

In this technical solution, a specific method for acquiring the corrected image information is further provided. Given that turning on the supplementary lighting assembly may produce images with excessively high or low luminance and thus the identification requirement cannot be met, after the supplementary lighting assembly is turned on, the first corrected image information is first collected, and then the luminance of the first corrected image information is determined. If the luminance is less than the first threshold, the duty cycle of the supplementary lighting assembly is increased, image information is re-collected, and the luminance of the image information is increased until corrected image information that can meet the requirement is acquired. In some cases, the luminance of the collected first corrected image information may be greater than or equal to the second threshold. This case indicates that the luminance of the first corrected image information is excessively high. In this case, the duty cycle of the supplementary lighting assembly may be reduced, image information is re-collected, and the luminance of the image information is reduced until corrected image information that can meet the requirement is acquired. In some cases, the luminance of the collected first corrected image information may be directly between the first threshold and the second threshold. In this case, it may be believed that the first corrected image information can meet the identification requirement, and the first corrected image information may be directly used as the corrected image information. Based on this, according to the control method in the embodiments of the present disclosure, the luminance of ambient light is monitored in real time based on image luminance, such that the illuminance of the fill light can be intelligently adjusted, thereby ensuring that the identification requirement for the image luminance can be met in both bright and dark environments, and ensuring the navigation and obstacle avoidance precision of the cleaning device.

In some embodiments, accurate millimeter-level obstacle avoidance may be achieved based on the image information or the corrected image information in combination with a triangulation ranging sensor.

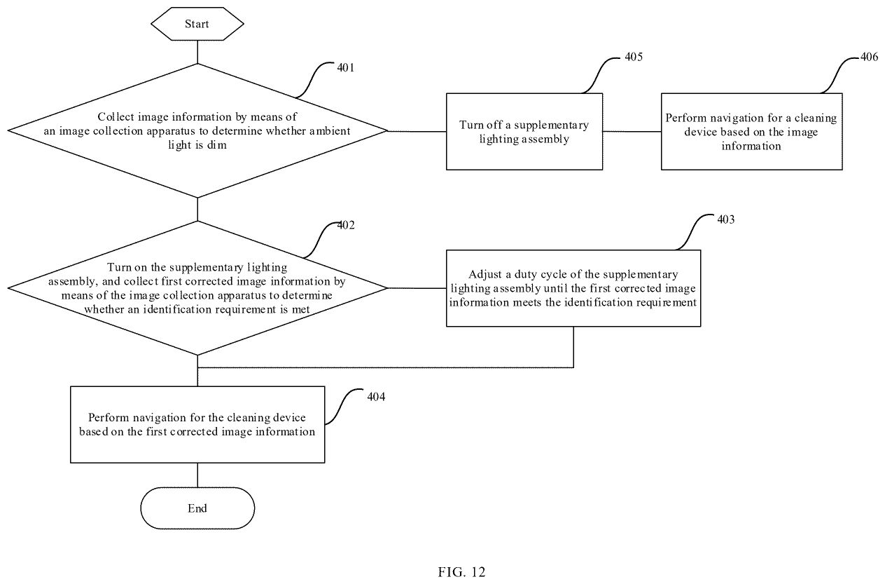

As shown in FIG. 12, in some embodiments, the control method for a cleaning device may include the following steps.

In step 401, image information is collected by means of an RGB image collection assembly to determine whether ambient light is dim; if yes, step 402 is performed, or if not, step 405 is performed.

In step 402, a supplementary lighting assembly is turned on, and first corrected image information is collected by means of the RGB image collection assembly to determine whether an identification requirement is met; if not, step 403 is performed, or if yes, step 404 is performed.

In step 403, a duty cycle of the supplementary lighting assembly is adjusted until the first corrected image information meets the identification requirement.

In step 404, navigation of the cleaning device is performed based on the first corrected image information.

In step 405, the supplementary lighting assembly is turned off.

In step 406, navigation of the cleaning device is performed based on the image information.

According to the control method in the embodiments of the present disclosure, the luminance of ambient light is monitored in real time based on image luminance, such that the light intensity of the supplementary lighting assembly is intelligently adjusted, thereby ensuring that the requirement of the AI identification for the image luminance can be met in both bright and dark environments, and ensuring smooth navigation and obstacle avoidance of the cleaning device.

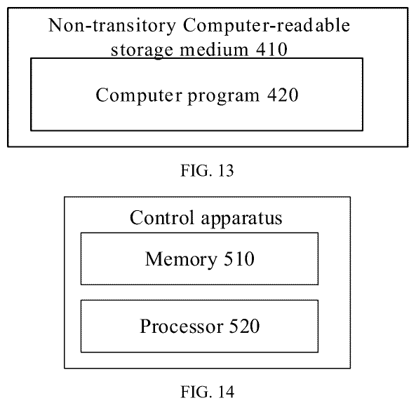

As shown in FIG. 13, a non-transitory computer-readable storage medium 410 is provided according to a fourth aspect of the embodiments of the present disclosure. The non-transitory computer-readable storage medium 410 stores a computer program 420 to implement the control method according to any one of the above technical solutions.

The non-transitory computer-readable storage medium 410 according to the embodiments of the present disclosure implements the control method according to any one of the above technical solutions. Therefore, the non-transitory computer-readable storage medium 410 has all the beneficial effects of the control method according to any one of the above technical solutions.

According to the non-transitory computer-readable storage medium 410 in the embodiments of the present disclosure, image information is first collected. If the image information can meet an identification requirement, the supplementary lighting assembly 100 does not need to be turned on. If the image information cannot meet the identification requirement, the supplementary lighting assembly 100 is turned on. Based on this, automatic control of turning on and off the supplementary lighting assembly 100 can be achieved, and the supplementary lighting assembly 100 is controlled to be turned on only when necessary. The corrected image information may be acquired by means of the supplementary lighting assembly 100, and thus a basis for navigation and obstacle avoidance of the cleaning device may be accurately provided based on the corrected image information. This can improve the precision of the movement of the cleaning device without irritating human eyes, resulting in a high user experience.

Based on such an understanding, the technical solutions according to the present disclosure may be embodied in the form of a software product. The software product may be stored in a non-volatile storage medium (which may be a CD-ROM, a USB flash drive, a portable hard drive, or the like), and includes several instructions to enable a computer device (which may be a personal computer, a server, a network device, or the like) to perform the method according to the implementation scenarios of the present disclosure.

As shown in FIG. 14, a control apparatus is provided according to a fifth aspect of the embodiments of the present disclosure. The control apparatus includes: a memory 510 storing a computer program and a processor 520 executing the computer program, where the processor 520, when executing the computer program, implements the control method according to any one of the above technical solutions.

The control apparatus according to the embodiments of the present disclosure implements the control method according to any one of the above technical solutions. Therefore, the control apparatus has all the beneficial effects of the control method according to any one of the above technical solutions.

According to the control apparatus in the embodiments of the present disclosure, image information is first collected. If the image information can meet an identification requirement, the supplementary lighting assembly 100 does not need to be turned on. If the image information cannot meet the identification requirement, the supplementary lighting assembly 100 is turned on. Based on this, automatic control of turning on and off the supplementary lighting assembly 100 can be achieved, and the supplementary lighting assembly 100 is controlled to be turned on only when necessary. The corrected image information may be acquired by means of the supplementary lighting assembly 100, and thus a basis for navigation and obstacle avoidance of the cleaning device may be accurately provided based on the corrected image information. This can improve the precision of the movement of the cleaning device without irritating human eyes, resulting in a high user experience.

In some embodiments, the control apparatus may further include a user interface, a network interface, a camera, a radio frequency (RF) circuit, a sensor, an audio circuit, a Wi-Fi assembly, and the like. The user interface may include a display, an input unit such as a keyboard, and the like. An optional user interface may also include a USB interface, a card reader interface, and the like. The network interface may optionally include a standard wired interface, a standard wireless interface (for example, a WI-FI interface), and the like.

In an exemplary embodiment, the control apparatus may further include an input/output interface and a display device. The functional units may communicate with each other via a bus. The memory stores a computer program. The processor is configured to execute the program stored in the memory to implement the method according to the above embodiments.

The above storage medium may further include an operating system and a network communication module. The operating system is the program that manages hardware and software resources of the entity device in the above method, and supports the operation of an information processing program and other software and/or programs. The network communication module is configured to implement the communication between the assemblies inside the storage medium, and the communication with other hardware and software in the information processing entity device.

Based on the descriptions of the above embodiments, those skilled in the art can clearly understand that the present disclosure may be implemented by the mode of software in combination with a necessary general hardware platform, or may be implemented by hardware.

The present disclosure is described with reference to flowcharts and/or block diagrams of the method, the device (system), and the computer program product according to the embodiments of the present disclosure. It should be understood that each procedure and/or block in the flowcharts and/or the block diagrams and a combination of the procedures and/or the blocks in the flowcharts and/or the block diagrams may be implemented by computer program instructions. These computer program instructions may be provided to a processor of a general-purpose computer, a special-purpose computer, an embedded computer, or other programmable data processing devices to generate a machine, such that an apparatus for achieving functions designated in one or more procedures of the flowcharts and/or one or more blocks of the block diagrams is generated based on instructions executed by the processors of the computers or other programmable data processing devices.

A supplementary lighting assembly is provided according to a first aspect of the embodiments of the present disclosure. The supplementary lighting assembly includes: a mounting member;
a light source, the light source being disposed on the mounting member; and
an adjustment member, the adjustment member being disposed on the mounting member, and the adjustment member being configured to adjust a boundary of a light beam emitted by the light source, such that part of the boundary of the light beam contracts inward toward a normal direction of the light beam.

In one embodiment, the adjustment member includes a curved lens, and the curved lens is connected to the mounting member; and
the light source includes an LED light source.

In one embodiment, a surface of the curved lens opposite to the light source is an adjustment surface, and the adjustment surface is arranged obliquely.

In one embodiment, the mounting member includes:
a first mounting member, the light source being connected to the first mounting member; and
a second mounting member, the adjustment member being disposed on the second mounting member, and the first mounting member being connected to the second mounting member.

In one embodiment, a horizontal direction of light emission from the light source is a first direction, a direction perpendicular to the horizontal direction is a second direction, and a light beam boundary, in the second direction, of part of a light beam emitted by the light source contracts inward toward the horizontal direction.

A cleaning device is provided according to a second aspect of the embodiments of the present disclosure. The cleaning device includes:
the supplementary lighting assembly according to any one of the above technical solutions; and
a cleaning device body, the supplementary lighting assembly being connected to the cleaning device body.

In one embodiment, the cleaning device body includes:
a housing, the housing being connected to the cleaning device body; and
a support, the support being configured to be connected to the housing,
where the supplementary lighting assembly is connected to the support.

In one embodiment, the cleaning device further includes:
a line laser assembly and an RGB image collection assembly, the line laser assembly and the RGB image collection assembly being disposed on the support.

In one embodiment, the cleaning device further includes:
a protective cover, the protective cover being configured to cover at least one of the RGB image collection assembly, the supplementary lighting assembly, and/or the line laser assembly,
where a region of the protective cover corresponding to the supplementary lighting assembly is formed with a hollowed-out portion.

In one embodiment, the housing is formed with a mounting hole, and the line laser assembly and/or the RGB image collection assembly transmit or receive a signal via the mounting hole.

In one embodiment, the cleaning device further includes:
a docking beacon receiving assembly, the docking beacon receiving assembly being configured to receive a docking signal transmitted by a base station,
where the docking beacon receiving assembly is disposed on the support.

In one embodiment, a traveling direction of the cleaning device body is a third direction, a height direction of the cleaning device body is a fourth direction, and a light beam boundary, in the fourth direction, of part of a light beam emitted by the light source contracts inward toward the third direction.

In one embodiment, in the fourth direction, an included angle between a light beam boundary, facing ground, of a light beam emitted by the light source and the third direction is a first included angle, and an included angle between a light beam boundary, facing away from the ground, of the light beam emitted by the light source and the third direction is a second included angle,
where the first included angle is greater than or equal to 21°, and the second included angle is less than or equal to 13°.

A control method for a cleaning device is provided according to a third aspect of the embodiments of the present disclosure. The control method is applicable to control the cleaning device according to any one of the above technical solutions, and includes:
collecting image information to acquire luminance information of the image information;
turning on the supplementary lighting assembly to acquire corrected image information in the case that the luminance information does not meet an identification requirement; and
performing navigation or obstacle avoidance for the cleaning device body based on the corrected image information.

In one embodiment, the step of turning on the supplementary lighting assembly to acquire the corrected image information in the case that the luminance information does not meet the identification requirement includes:
turning on the supplementary lighting assembly to acquire first corrected image information in the case that the luminance information does not meet the identification requirement;
increasing a duty cycle of the supplementary lighting assembly in the case that luminance of the first corrected image information is less than a first threshold, and reacquiring image information until corrected image information capable of meeting the identification requirement is acquired;
reducing the duty cycle of the supplementary lighting assembly in the case that the luminance of the first corrected image information is greater than or equal to a second threshold, and reacquiring image information until corrected image information capable of meeting the identification requirement is acquired; and
using the first corrected image information as the corrected image information in the case that the luminance of the first corrected image information is greater than or equal to the first threshold and is less than or equal to the second threshold, where a value of the first threshold is less than that of the second threshold.

A non-transitory computer-readable storage medium is provided according to a fourth aspect of the embodiments of the present disclosure.

The non-transitory computer-readable storage medium stores a computer program to implement the control method according to any one of the above technical solutions.

A control apparatus is provided according to a fifth aspect of the embodiments of the present disclosure. The control apparatus includes:
a memory storing a computer program; and
a processor executing the computer program,
where the processor, when executing the computer program, implements the control method according to any one of the above technical solutions.

In the present disclosure, the terms “first”, “second”, and “third” are merely used for descriptive purposes, and shall not be understood as indicating or implying relative importance. The term “plurality of” means two or more, unless explicitly defined otherwise. The terms “mount”, “interconnect”, “connect”, “fix”, and the like should be interpreted in their broad senses. For example, “connect” may be a fixed connection, a detachable connection, or an integral connection, and “interconnect” may be a direct connection, or an indirect connection via an intermediate. For those of ordinary skill in the art, the specific meanings of the above terms in the present disclosure can be understood according to specific conditions.

In the description of the present disclosure, it should be understood that orientations or positional relationships indicated by terms such as “upper”, “lower”, “left”, “right”, “front”, and “rear” are those shown based on the drawings, and are merely intended to facilitate and simplify description of the present disclosure rather than to indicate or imply that the indicated apparatus or unit must have a specific direction and be structured and operated according to the specific orientation, and should not be construed as limiting the present disclosure.

In the description of the specification, the description of terms “one embodiment”, “some embodiments”, “a specific embodiment”, and the like means that specific features, structures, materials, or characteristics described in connection with the embodiments or examples are included in at least one embodiment or example of the present disclosure. In the specification, the schematic description of the aforementioned terms does not necessarily refer to the same embodiment or example. Moreover, the specific features, structures, materials, or characteristics described may be combined in a suitable manner in any one or more embodiments or examples.

The above are only preferred embodiments of the present disclosure and are not intended to limit the present disclosure. For those skilled in the art, the present disclosure can be modified and varied. Any modification, equivalent substitution, improvement, and the like made within the spirit and principle of the present disclosure shall all fall within the protection scope of the present disclosure.

1. A supplementary lighting assembly, comprising:
a mounting member;
a light source, disposed on the mounting member; and
an adjustment member, disposed on the mounting member, and configured to adjust a boundary of a light beam emitted by the light source, such that part of the boundary of the light beam contracts inward toward a normal direction of the light beam.

2. The supplementary lighting assembly according to claim 1, wherein
the adjustment member comprises a curved lens, and the curved lens is connected to the mounting member; and
the light source comprises an LED light source.

3. The supplementary lighting assembly according to claim 2, wherein
a surface of the curved lens opposite to the light source is an adjustment surface, and the adjustment surface is arranged obliquely.

4. The supplementary lighting assembly according to claim 1, wherein the mounting member comprises:
a first mounting member, wherein the light source is connected to the first mounting member; and
a second mounting member, wherein the adjustment member is disposed on the second mounting member, and the first mounting member is connected to the second mounting member.

5. The supplementary lighting assembly according to claim 1, wherein
a horizontal direction of light emission from the light source is a first direction, a direction perpendicular to the horizontal direction is a second direction, and a light beam boundary, in the second direction, of part of a light beam emitted by the light source contracts inward toward the horizontal direction.

6. A cleaning device, comprising:
the supplementary lighting assembly according to claim 1; and
a cleaning device body, wherein the supplementary lighting assembly is connected to the cleaning device body.

7. The cleaning device according to claim 6, further comprising:
a housing, connected to the cleaning device body; and
a support, configured to be connected to the housing,
wherein the supplementary lighting assembly is connected to the support.

8. The cleaning device according to claim 7, further comprising:
a line laser assembly and an RGB image collection assembly, disposed on the support.

9. The cleaning device according to claim 8, further comprising:
a protective cover, configured to cover at least one of the RGB image collection assembly, the supplementary lighting assembly, and/or the line laser assembly,
wherein a region of the protective cover corresponding to the supplementary lighting assembly is formed with a hollowed-out portion.

10. The cleaning device according to claim 8, wherein
the housing is formed with a mounting hole, and the line laser assembly and/or the RGB image collection assembly transmit or receive a signal via the mounting hole.

11. The cleaning device according to claim 7, further comprising:
a docking beacon receiving assembly, configured to receive a docking signal transmitted by a base station,
wherein the docking beacon receiving assembly is disposed on the support.

12. The cleaning device according to claim 6, wherein
a traveling direction of the cleaning device body is a third direction, a height direction of the cleaning device body is a fourth direction, and a light beam boundary, in the fourth direction, of part of a light beam emitted by the light source contracts inward toward the third direction.

13. The cleaning device according to claim 12, wherein
in the fourth direction, an included angle between a light beam boundary, facing ground, of a light beam emitted by the light source and the third direction is a first included angle, and an included angle between a light beam boundary, facing away from the ground, of the light beam emitted by the light source and the third direction is a second included angle,
wherein the first included angle is greater than the second included angle.

14. A control method for a cleaning device, applicable to control the cleaning device according to claim 6, the control method comprising:
collecting image information to acquire luminance information of the image information;
turning on the supplementary lighting assembly to acquire corrected image information in the case that the luminance information does not meet an identification requirement; and
performing navigation or obstacle avoidance for the cleaning device body based on the corrected image information.

15. The control method according to claim 14, wherein the step of turning on the supplementary lighting assembly to acquire the corrected image information in the case that the luminance information does not meet the identification requirement comprises:
turning on the supplementary lighting assembly to acquire first corrected image information in the case that the luminance information does not meet the identification requirement;
increasing a duty cycle of the supplementary lighting assembly in the case that luminance of the first corrected image information is less than a first threshold, and reacquiring image information until corrected image information capable of meeting the identification requirement is acquired;
reducing the duty cycle of the supplementary lighting assembly in the case that the luminance of the first corrected image information is greater than or equal to a second threshold, and reacquiring image information until corrected image information capable of meeting the identification requirement is acquired; and
using the first corrected image information as the corrected image information in the case that the luminance of the first corrected image information is greater than or equal to the first threshold and is less than or equal to the second threshold,
wherein a value of the first threshold is less than that of the second threshold.

16. A non-transitory computer-readable storage medium, wherein
the non-transitory computer-readable storage medium stores a computer program to implement the control method according to claim 14.

17. A control apparatus, comprising:
a memory storing a computer program; and
a processor executing the computer program,
wherein the processor, when executing the computer program, implements the control method according to claim 14.
